(19) United States
(12) Patent Application Publication
(10) Pub. No.: US 2026/0298102 A1
(43) Pub. Date: Oct. 1, 2026

(54) SEAL, ASSEMBLY USING THE SAME, AND METHOD OF INSTALLATION

(71) Applicant: RTX CORPORATION, Farmington, CT (US)

(72) Inventors: Raymond SURACE, Newington, CT (US); Howard LILES, Newington, CT (US); Tyler VINCENT, Portland, CT (US); Robert WHITE, III, Meriden, CT (US)

(73) Assignee: RTX CORPORATION, Farmington, CT (US)

(21) Appl. No.: 19/090,304

(22) Filed: Mar. 25, 2025

(51) Int. Cl. F01D 11/00; F16J 15/3204

(52) U.S. Cl. CPC F01D 11/005; F16J 15/3204; F05D 2230/60; F05D 2240/55; F05D 2300/6033

(57) ABSTRACT

A seal for an assembly containing a ceramic matrix composite (CMC) vane disposed in contact with a tangential onboard injector or an inner air seal outer diameter, comprising at least one seal disposed within a groove formed at a sealing interface between the CMC vane and the tangential onboard injector or the inner air seal outer diameter, wherein the groove comprises an upper surface of an upper sealing interface surface formed within an inner diameter platform of the CMC vane and a lower surface of a lower sealing interface surface, and opposite the upper surface, formed within the tangential onboard injector or the inner air seal outer diameter.

### FIELD OF THE INVENTION

The subject matter disclosed herein relates to a seal and, in particular, to a seal for use in gas turbine engines.

### BACKGROUND OF THE INVENTION

Traditional single crystal nickel cast turbine vanes also have a secondary function. The vanes also deliver cooling or purge air bled from the compressor outer diameter to the turbine blades and rotor rim cavities adjacent to a vane row. The delivery of cooling or purge air bleed can be done by flowing the cooling or purge air from the outer diameter of the turbine vane, through a radial pass-through cavity, or cavities, within the vane, and also through a tube welded to the inner diameter of the turbine vane. As the air flows through the turbine vane, the cooling or purge air may exit the welded tube and be used to purge the rotor rim cavity. Conversely, the cooling or purge air may pass through a second interfacing tube, and into an internal cavity of a tangential on-board injector (TOBI). At that point, the cooling or purge air may exit the TOBI through apertures and be used to purge the rotor rim cavity. In addition, or instead of, the cooling or purge air may pass through a series of integrally cast TOBI nozzles. These TOBI nozzles pre-swirl the cooling or purge air as the air exits the TOBI. The exiting cooling or purge air flows to get on-board the adjacent rotor providing cooling air to the blades. The same functionality is desired in an engine with ceramic matrix composite (CMC) turbine vanes, rather than single crystal nickel cast turbine engine vanes. However, the aforementioned transfer tubes cannot be welded to the inner diameter of the turbine CMC vane.

Consequently, there exists a need for an assembly having a CMC vane connected to a TOBI that achieves a seal and delivery of cooling or purge air bleed without the structural elements found in prior designs.

### SUMMARY OF THE INVENTION

The present disclosure is directed, in a first aspect, to a seal for an assembly containing a ceramic matrix composite (CMC) vane disposed in contact with a tangential onboard injector or an outer diameter of an inner air seal, comprising: at least one seal disposed within a groove formed at a sealing interface between the CMC vane and the tangential onboard injector or the outer diameter inner air seal, wherein the groove comprises an upper surface of an upper sealing interface surface formed within an inner diameter platform of the CMC vane and a lower surface of a lower sealing interface surface, and opposite the upper surface, formed within the tangential onboard injector or the inner air seal outer diameter.

In further embodiments of the present disclosure, including further embodiments of the above exemplary embodiments, the seal comprises a one-piece seal having a first end and a second end that slidingly engage and overlap each other.

In further embodiments of the present disclosure, including further embodiments of the above exemplary embodiments, the one-piece seal comprises one of the following shapes: teardrop, clip and airfoil cavity.

In further embodiments of the present disclosure, including further embodiments of the above exemplary embodiments, the seal comprises a two-piece seal having an inner seal segment including at least one inner slot, an outer seal segment including at least one outer slot, wherein the outer seal segment and the inner seal segment slidingly engage and overlap one another.

In further embodiments of the present disclosure, including further embodiments of the above exemplary embodiments, the two-piece seal comprises one of the following shapes: teardrop, clip and airfoil cavity.

In further embodiments of the present disclosure, including further embodiments of the above exemplary embodiments, the seal comprises a two-piece seal having an aft seal segment including one or more crimped portions and a fore seal segment, wherein the fore seal segment receives the crimped portions and retains the aft seal segment.

In further embodiments of the present disclosure, including further embodiments of the above exemplary embodiments, the two-piece seal comprises one of the following shapes: teardrop, clip and airfoil cavity.

In further embodiments of the present disclosure, including further embodiments of the above exemplary embodiments, the seal is disposed in contact with an upper base surface of the upper surface and a lower base surface of the lower surface.

In further embodiments of the present disclosure, including further embodiments of the above exemplary embodiments, under pressure, the seal slidingly engages and maintains contact with an outer upper side surface of the upper surface and an outer lower side surface of the lower surface.

In another embodiment, the present disclosure is directed to a assembly for a gas turbine engine, comprising: a CMC vane having a CMC vane inner diameter platform including an upper sealing interface surface with an upper surface of a groove; a tangential onboard injector including a lower sealing interface surface with a lower surface of the groove, or an inner air seal outer diameter including a lower sealing interface surface with a lower surface of the groove, the CMC vane inner diameter platform and either the tangential onboard injector or the inner air seal outer diameter are disposed in contact to form an interface comprising the upper sealing interface surface and the lower sealing interface surface; and a seal disposed within the groove formed by the upper surface and the lower surface.

In further embodiments of the present disclosure, including further embodiments of the above exemplary embodiments, the seal comprises a one-piece seal having a first end and a second end that slidingly engage and overlap each other.

In further embodiments of the present disclosure, including further embodiments of the above exemplary embodiments, the one-piece seal comprises one of the following shapes: teardrop, clip and airfoil cavity.

In further embodiments of the present disclosure, including further embodiments of the above exemplary embodiments, the seal comprises a two-piece seal having an inner seal segment including at least one inner slot, an outer seal segment including at least one outer slot, wherein the outer seal segment and the inner seal segment slidingly engage and overlap one another.

In further embodiments of the present disclosure, including further embodiments of the above exemplary embodiments, the two-piece seal comprises one of the following shapes: teardrop, clip and airfoil cavity.

In further embodiments of the present disclosure, including further embodiments of the above exemplary embodiments, the seal comprises a two-piece seal having an aft seal segment including one or more crimped portions and a fore seal segment, wherein the fore seal segment receives the crimped portions and retains the aft seal segment.

In further embodiments of the present disclosure, including further embodiments of the above exemplary embodiments, the two-piece seal comprises one of the following shapes: teardrop, clip and airfoil cavity.

In yet another embodiment, the present disclosure is directed to a method of installing a seal in an assembly for a gas turbine engine, comprising the steps of: providing a CMC vane having a CMC vane inner diameter platform including an upper sealing interface surface with an upper surface of a groove; providing either a tangential onboard injector including a lower sealing interface surface with a lower surface of the groove or an inner air seal outer diameter including a lower sealing interface surface with a lower surface of the groove; placing a seal within either the upper surface or the lower surface of the groove; and disposing the upper sealing interface surface in contact with the lower sealing interface surface.

In further embodiments of the present disclosure, including further embodiments of the above exemplary embodiments, the seal comprises a one-piece seal having a first end and a second end that slidingly engage and overlap each other, and the one-piece seal comprises one of the following shapes: teardrop, clip and airfoil cavity.

In further embodiments of the present disclosure, including further embodiments of the above exemplary embodiments, the seal comprises a two-piece seal having an inner seal segment including at least one inner slot, an outer seal segment including at least one outer slot, wherein the outer seal segment and the inner seal segment slidingly engage and overlap one another, and the two-piece seal comprises one of the following shapes: teardrop, clip and airfoil cavity.

In further embodiments of the present disclosure, including further embodiments of the above exemplary embodiments, the seal comprises a two-piece seal having an aft seal segment including one or more crimped portions and a fore seal segment, wherein the fore seal segment receives the crimped portions and retains the aft seal segment, and the two-piece seal comprises one of the following shapes: teardrop, clip and airfoil cavity.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a schematic, cross-sectional view of a gas turbine engine, not drawn to scale.

FIG. 2 is a cross-sectional view of an assembly within the gas turbine engine of FIG. 1, not drawn to scale.

FIG. 3 is a cross-sectional view of an exemplary seal of FIG. 2, not drawn to scale, illustrating an exemplary seal housed within a groove formed between a CMC vane and a TOBI.

FIG. 4 is a cross-sectional view of the exemplary seal under pressure during operation of the gas turbine engine, not drawn to scale.

FIG. 5A is a perspective view of an exemplary seal, not drawn to scale.

FIG. 5B is a top plan view of the exemplary seal of FIG. 5A, not drawn to scale.

FIG. 6A is a perspective view of another exemplary seal, not drawn to scale.

FIG. 6B is a side elevation view of the exemplary seal of FIG. 6A, not drawn to scale.

FIG. 7A is a perspective view of yet another exemplary seal, not drawn to scale.

FIG. 7B is a top plan view of a fore seal segment of the exemplary seal of FIG. 7A, not drawn to scale.

FIG. 7C is a top plan view of an aft seal segment of the exemplary seal of FIG. 7A, not drawn to scale.

FIG. 8 is an exemplary shape of the exemplary seal disclosed herein, not drawn to scale.

FIG. 9 is another exemplary shape of the exemplary seal disclosed herein, not drawn to scale.

FIG. 10 is yet another exemplary shape of the exemplary seal disclosed herein, not drawn to scale.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

The present disclosure is directed to an exemplary seal for use in sealing the interface between a ceramic matrix composite-containing CMC vane (CMC vane) and either a tangential on-board injector (TOBI) or an inner air seal ring. The exemplary seal may allow cooling or purging fluid, e.g., air flow, to pass from at least one radial through-flow cavity within the CMC vane into another radial through-flow cavity of the TOBI or inner air seal ring with minimal leakage. Without the exemplary seal, the inner diameter of a CMC vane may contact the outer diameter of a TOBI and form an interface, yet not form an effective seal. That is, the CMC vane may lean and tilt relative to the TOBI due to aerodynamic and thermal loading. As a result, a gap may open up at the interface. However, the exemplary seal disclosed herein may prevent such a gap. Although the exemplary seal disclosed herein is discussed with respect to a TOBI or inner air seal ring, the seal may be utilized with various gas turbine engine components, e.g., a segmented platform or segmented inner air seal.

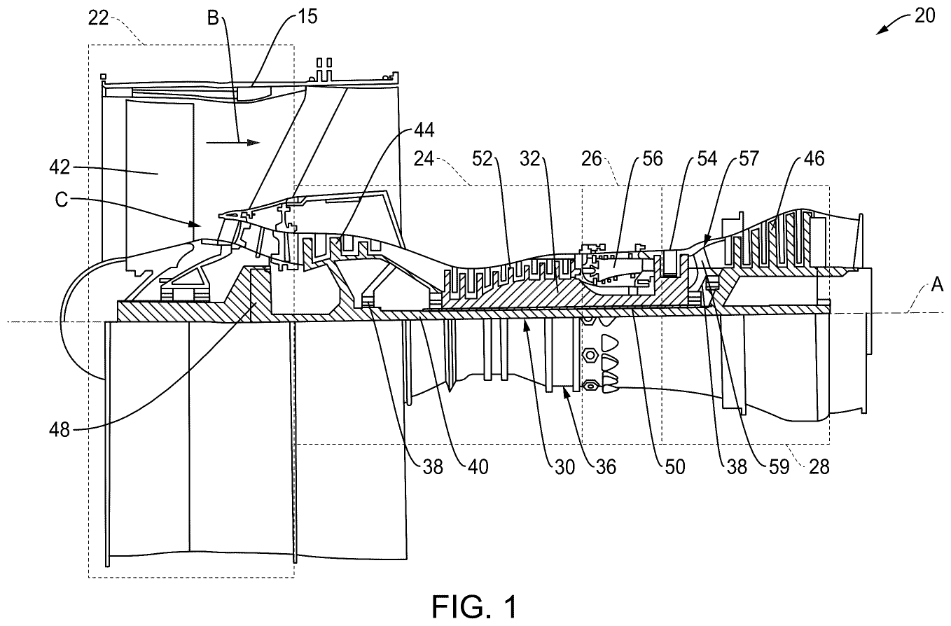

FIG. 1 schematically illustrates an example of a gas turbine engine 20 (i.e., a two-spool turbofan) which includes a fan section 22, a compressor section 24, a combustor section 26, and a turbine section 28. Fan section 22 drives air along a bypass flow path B in a bypass duct defined within a housing 15, and also along a core flow path C for compression in compressor section 24, with subsequent introduction into combustor section 26, followed by expansion through turbine section 28. Although FIG. 1 depicts a two-spool turbofan gas turbine engine, it should be understood that the concepts described herein are not limited to use with two-spool turbofans engines and may be applied to other types of turbine engines.

Engine 20 generally includes a low speed spool 30 and a high speed spool 32 mounted for rotation about an engine central longitudinal axis A, relative to an engine static structure 36, via several bearing systems 38. Various bearing systems 38 at various locations may alternatively or additionally be provided. The location of bearing systems 38 may be varied as appropriate to the application.

The low speed spool 30 generally includes an inner shaft 40 that interconnects, a first (or low) pressure compressor 44 and a first (or low) pressure turbine 46. Inner shaft 40 is connected to fan 42 through a speed change mechanism, which in this exemplary embodiment is illustrated as a geared structure 48 to drive fan 42 at a lower speed than the low speed spool 30. High speed spool 32 includes an outer shaft 50 that interconnects a second (or high) pressure compressor 52 and a second (or high) pressure turbine 54. Combustor 56 is positioned between high pressure compressor 52 and high-pressure turbine 54. A mid-turbine frame 57 of the engine static structure 36 may be arranged generally between the high-pressure turbine 54 and the low-pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core air flow is first compressed by low pressure compressor 44, and then by the high-pressure compressor 52. Thereafter, the core air flow is mixed and burned with fuel in combustor 56, then expanded in high pressure turbine 54 and low-pressure turbine 46. The mid-turbine frame 57 includes airfoils 59 which are in the core airflow path C. The turbines 46 and 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low-pressure compressor, or aft of the combustor section 26 or even aft of turbine section 28, and fan 42 may be positioned forward or aft of the location of gear system 48.

The turbine section 28 includes at least one rotor and at least one blade extending radially outwardly from the rotor. The turbine section 28 may further include a blade outer air seal(s) (BOAS(s)). The blade outer air seal can be an assembly of a plurality of BOAS segments that together form an annular shaped shroud around the engine's central longitudinal axis A which is positioned between an outer casing of the engine and the turbine blade(s) of the turbine section.

As noted above, gas turbine engine components can be made from CMC materials. Such components include blade outer air seal(s) (BOAS(s)), BOAS segments, other seals, vane airfoils and platforms therefor, blade airfoils and platforms therefor, and combustor liners. In general, these CMC components are prepared by first creating a CMC preform which serves as the initial framework for creating the CMC component.

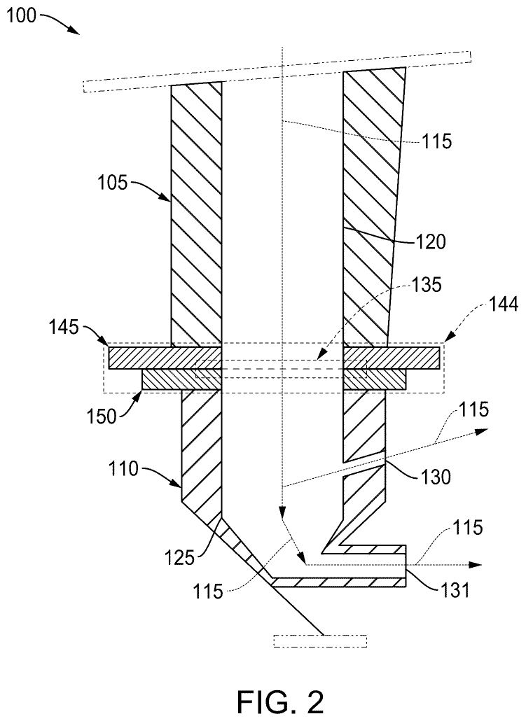

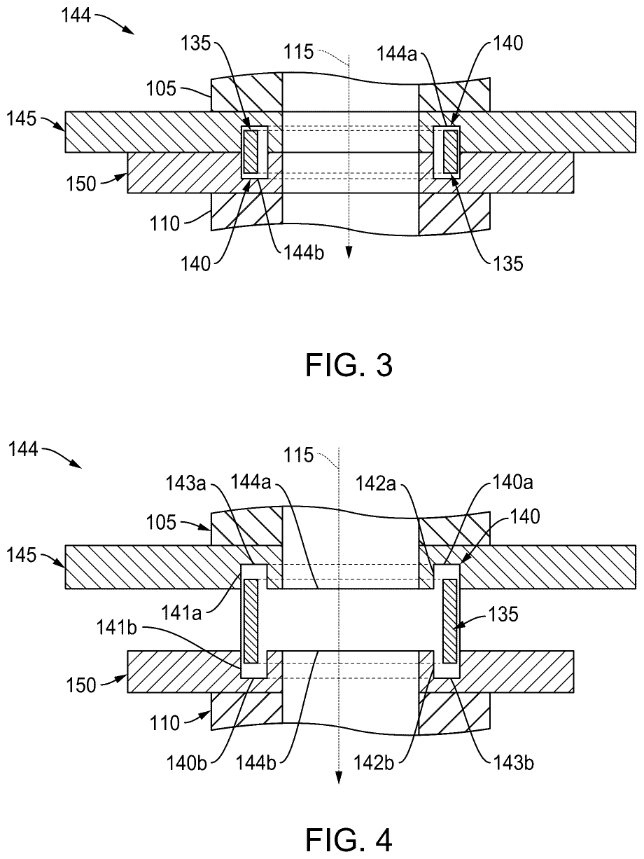

Referring now to FIGS. 2-4, an exemplary assembly 100 having a CMC vane 105 disposed in contact with either a tangential on-board injector 110 (TOBI 110) or the outer diameter of an inner air seal (not shown), may be positioned just before a turbine blade row in the turbine section 28 of FIG. 1 (see also FIG. 2). Generally, the assembly 100 may receive air from the compressor or a source of cooling air (as indicated by arrow 115), pass the cooling air through an internal cavity 120 of the CMC vane 105 and another internal cavity 125 of the TOBI 110, and discharge the cooling air through at least one nozzle 130, 131 of TOBI 110. The nozzles 130, 131 typically impart a swirling movement and directs the discharging stream of cooling air 115 tangentially to the rotating turbine disk of the turbine section 28. The CMC vane 105 and TOBI 110 may contact each other at an interface 144 having an exemplary seal 135 housed within a groove 140 comprising upper and lower surfaces 140a, 140b that may be formed within an inner diameter platform 145 of the CMC vane 105 and an outer diameter platform 150 of the TOBI 110 (or inner air seal), respectively. As illustrated in FIG. 3, the inner diameter platform 145 may have formed therein an upper sealing interface surface 144a, while the outer diameter platform 150 may have formed therein a lower sealing interface surface 144b. In addition, as shown in FIG. 4, each upper and lower surface 140a, 140b may include outer upper and lower side surfaces 141a, 141b, respectively; inner upper and lower side surfaces 142a, 142b, respectively; and, upper and lower base surfaces 143a, 143b, respectively.

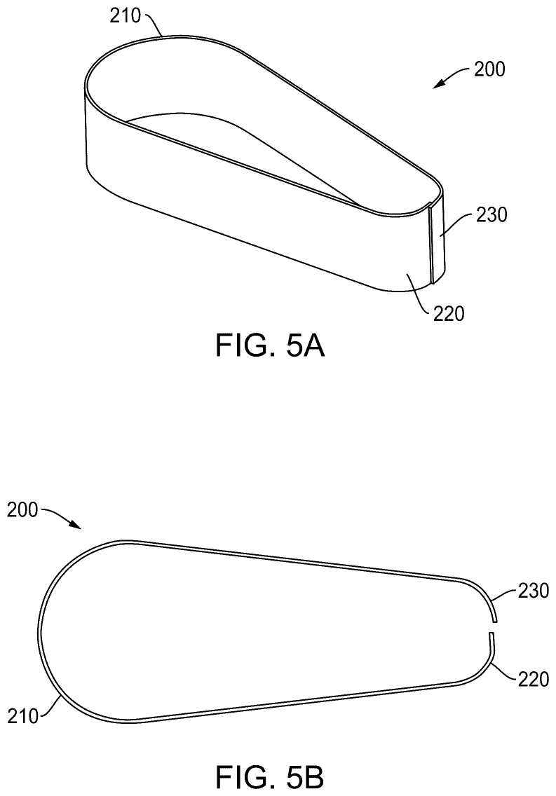

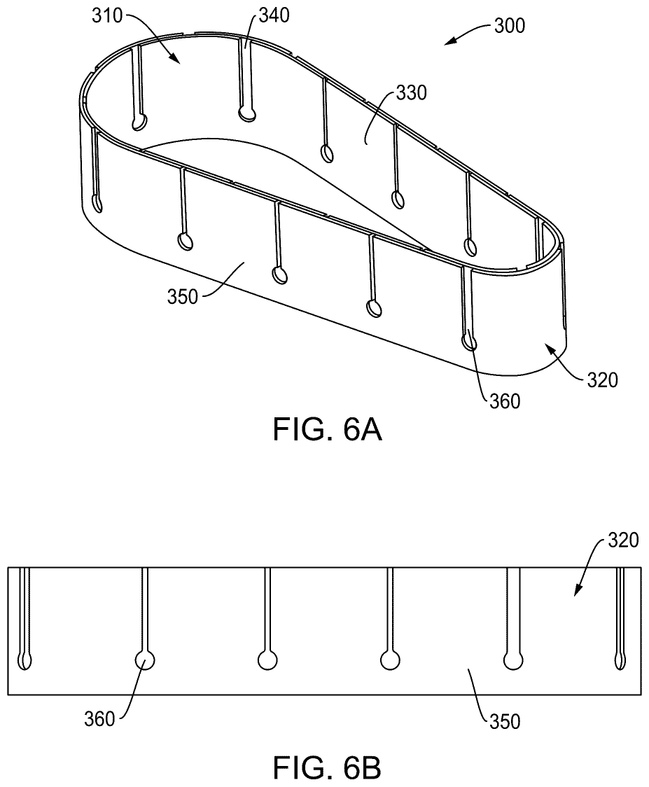

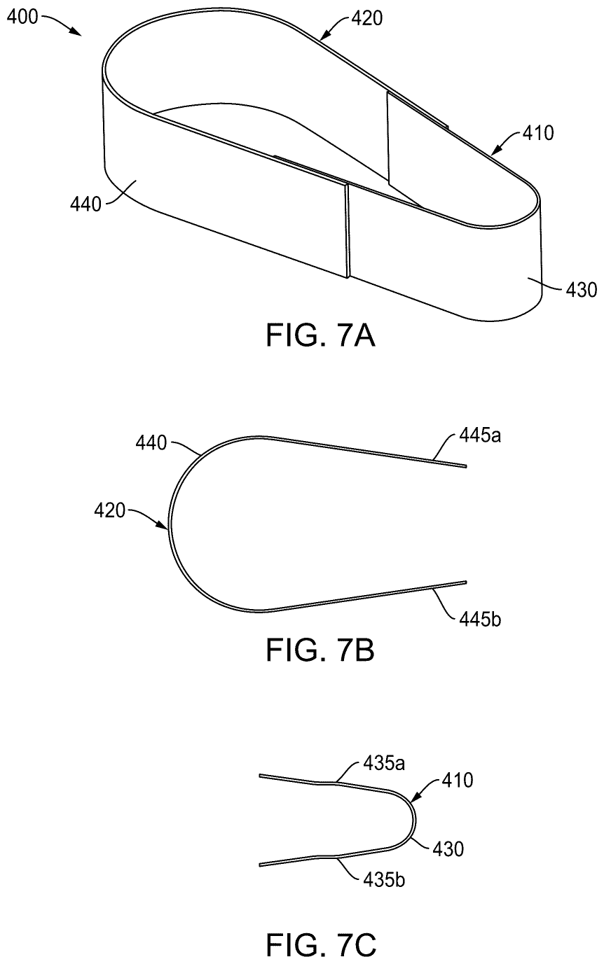

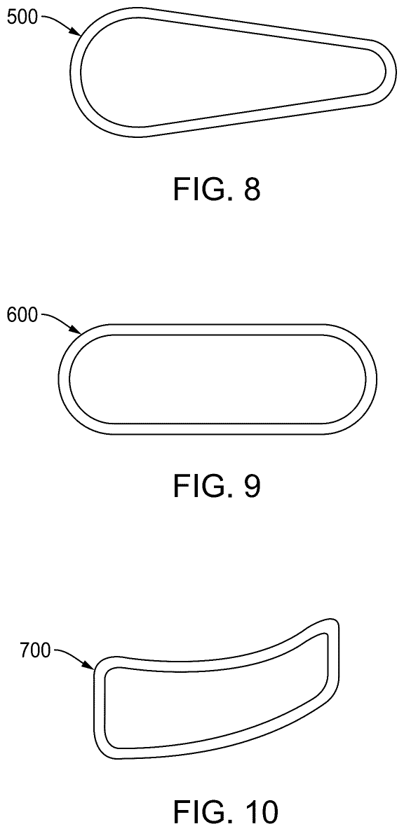

Referring to FIGS. 5A-9, several exemplary seals having a variety of shapes are illustrated. In at least one embodiment, an exemplary seal may be a one-piece seal 200 (see FIG. 5A), a two-piece seal 300 (see FIG. 6A) or another two-piece seal 400 (see FIG. 7A). Although each exemplary seal 200, 300, 400 are illustrated having a particular shape, each seal 200, 300, 400 may exhibit and possess any shape suitable for fitting within, e.g., a groove, and achieving and maintaining an air tight seal. For example, suitable shapes may include, but are not limited to, a teardrop shape 500 (see FIG. 8), a paper clip shape 600 (see FIG. 9) or an airfoil cavity shape 700, e.g., cambered airfoil cavity (see FIG. 10). In particular, the airfoil cavity shape 700 may exhibit and possess a shape resembling the perimeter of the internal cavity 120 within the CMC vane 105. In every design, whether illustrated or only contemplated herein, the flexibility of the exemplary seal design may enable the pressurized seal to conform to and contact the outer side surfaces 141a, 141b of the upper and lower surfaces 140a, 140b of the groove 140 of the CMC vane 105 and the TOBI 110 (or inner air seal).

Referring to FIGS. 5A and 5B, in at least one embodiment, an exemplary one-piece seal 200 may have a body 210 constructed using a single piece of material. Any material capable of deforming and expanding under pressure is suitable for use herein. In one embodiment, suitable materials may include, but are not limited to, nickel and its alloys; cobalt and its alloys; chrome and its alloys; individually, and combinations thereof; and the like. For instance, a combination may include a nickel alloy body having, e.g., a cobalt or cobalt-chrome coating. In another embodiment, suitable materials may include, but are not limited to, a ceramic matrix composite, e.g., a SiC matrix containing SiC fibers, that optionally may be coated with at least one layer of, e.g., silicon, mullite; individually, and combinations thereof, and the like. The body 210 may include a first end 220 and a second end 230. When disposed within the groove 140, and furthermore, when pressurized, the first and second ends 220, 230 may slidingly engage and overlap each other. In at least one embodiment, the one-piece seal 200 may possess any shape capable of fitting within the groove 140. For example, the one-piece seal 200 may have, but is not limited to, the teardrop shape 500 (see FIG. 8), the paper clip shape 600 (see FIG. 9) or the airfoil cavity shape 700 (see FIG. 10).

Referring to FIGS. 6A and 6B, in at least one embodiment, an exemplary two-piece seal 300 may include an inner seal segment 310 and an outer seal segment 320. The inner seal segment 310 may include a body 330 having at least one inner slot 340, while the outer seal segment 320 may include a body 350 at least one outer slot 360. When disposed within the groove 140, exterior surface of the pressurized inner seal segment 310 slidingly engages the interior surface of the outer seal segment 320 to form the two-piece seal 300. During operation, the inner slots 340 and outer slots 360 may facilitate the expansion and contraction of each segment 310, 320, respectively, within the groove 140. Any material capable of expanding under pressure is suitable for use herein. Those materials found suitable for use for the exemplary one-piece seal 200 are equally suitable for the exemplary two-piece seal 300. In at least one embodiment, the two-piece seal 300 may possess any shape capable of fitting within the groove 140. For example, the two-piece seal 300 may have, but is not limited to, the teardrop shape 500 (see FIG. 8), the paper clip shape 600 (see FIG. 9) or the airfoil cavity shape 700 (see FIG. 10).

Referring to FIGS. 7A-7C, in at least one embodiment, another exemplary two-piece seal 400 may include an aft seal segment 410 and a fore seal segment 420. The aft seal segment 410 may have a body 430 having crimped portions 435a, 435b, while the fore seal segment 420 may have a body 440 having a first end 445a and a second end 445b. The first and second ends 445a, 445b may be designed to receive the first and second crimped portions 435a, 435b, respectively. Once received, the aft and fore seal segments 410, 420 contact each other. When disposed within the groove 140, exterior surfaces of the first and second crimped portions 435a, 435b slidingly engage the interior surfaces of the first and second ends 445a, 445b to form the two-piece seal 400. During operation when pressurized, the sliding engagement between the aft and fore seal segments 410, 420 may facilitate the expansion and contraction of the seal 400 within the groove 140. Any material capable of expanding under pressure is suitable for use herein. Those materials found suitable for use for the exemplary one-piece seal 200 and two-piece seal 300 are equally suitable for the exemplary two-piece seal 400. In at least one embodiment, the two-piece seal 400 may possess any shape capable of fitting within the groove 140. For example, the two-piece seal 400 may have, but is not limited to, the teardrop shape 500 (see FIG. 8), the paper clip shape 600 (see FIG. 9) or the airfoil cavity shape 700 (see FIG. 10).

When disposing any potential exemplary seal within the groove 140, the exterior surface of the exemplary seal may be disposed in contact with either base surface 143a, 143b of either upper or lower surfaces 140a, 140b in either the upper sealing interface surface 144a or the lower sealing interface surface 144b, respectively. Whether the exemplary seal is a one-piece or a two-piece, the one-piece seal 200 and two-piece seals 300, 400 may be disposed within either upper or lower surface 140a, 140b, including one or more temporary couplings, e.g., wax, adhesive; individually and combinations thereof; to retain the seals 200, 300, 400. When the CMC vane 105 and TOBI 110 (or inner air seal) are disposed adjacent each other, the upper sealing interface surface 144a and lower sealing interface surface 144b make contact and form the groove 140 that houses the exemplary seal (see FIG. 2).

During operation of the gas turbine engine, the pressure of the cooling or purge fluid traveling through the CMC vane 105 and exemplary seal into the TOBI 110 (PINNER) (or inner air seal) may be greater than the pressure of the fluid below the inner diameter platform 145 and around and proximate to the outer perimeter of the interface 144 (POUTER). This pressure differential may facilitate the exemplary seal contacting the outer side surfaces 141a, 141b of the upper and lower surfaces 140a, 140b, respectively. During operation, the exemplary seal and interface 140 may remain in contact even if the upper sealing interface surface 144a may no longer contact the lower sealing interface surface 144b (see FIG. 4).

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

1. A seal for an assembly containing a ceramic matrix composite (CMC) vane disposed in contact with a tangential onboard injector or an outer diameter of an inner air seal, comprising:
at least one seal disposed within a groove formed at a sealing interface between the CMC vane and the tangential onboard injector or the outer diameter inner air seal,
wherein the groove comprises an upper surface of an upper sealing interface surface formed within an inner diameter platform of the CMC vane and a lower surface of a lower sealing interface surface, and opposite the upper surface, formed within the tangential onboard injector or the inner air seal outer diameter,
wherein the seal comprises a two-piece seal having an aft seal segment including one or more crimped portions and a fore seal segment, wherein the fore seal segment receives the crimped portions and retains the aft seal segment.

2. (canceled)

3. (canceled)

4. (canceled)

5. (canceled)

6. (canceled)

7. The seal of claim 1, wherein the two-piece seal resembles one of the following shapes: teardrop, clip and airfoil cavity.

8. The seal of claim 1, wherein the seal is disposed in contact with an upper base surface of the upper surface and a lower base surface of the lower surface.

9. The seal of claim 1, wherein, under pressure, the seal slidingly engages and maintains contact with an outer upper side surface of the upper surface and an outer lower side surface of the lower surface.

10. An assembly for a gas turbine engine, comprising:
a ceramic matrix composite vane having a ceramic matrix composite vane inner diameter platform including an upper sealing interface surface with an upper surface of a groove;
a tangential onboard injector including a lower sealing interface surface with a lower surface of the groove, or
an inner air seal outer diameter including a lower sealing interface surface with a lower surface of the groove,
the CMC vane inner diameter platform and either the tangential onboard injector or the inner air seal outer diameter are disposed in contact to form an interface comprising the upper sealing interface surface and the lower sealing interface surface; and
a seal disposed within the groove formed by the upper surface and the lower surface,
wherein the seal comprises a two-piece seal having an aft seal segment including one or more crimped portions and a fore seal segment, wherein the fore seal segment receives the crimped portions and retains the aft seal segment.

11. (canceled)

12. (canceled)

13. (canceled)

14. (canceled)

15. (canceled)

16. The assembly of claim 10, wherein the two-piece seal resembles one of the following shapes: teardrop, clip and airfoil cavity.

17. A method of installing a seal in an assembly for a gas turbine engine, comprising the steps of:
providing a ceramic matrix composite vane having a ceramic matrix composite vane inner diameter platform including an upper sealing interface surface with an upper surface of a groove;
providing either a tangential onboard injector including a lower sealing interface surface with a lower surface of the groove or an inner air seal outer diameter including a lower sealing interface surface with a lower surface of the groove;
placing a seal within either the upper surface or the lower surface of the groove; and
disposing the upper sealing interface surface in contact with the lower sealing interface surface,
wherein the seal comprises a two-piece seal having an aft seal segment including one or more crimped portions and a fore seal segment, wherein the fore seal segment receives the crimped portions and retains the aft seal segment.

18. (canceled)

19. (canceled)

20. The method of claim 17, wherein the two-piece seal resembles one of the following shapes: teardrop, clip and airfoil cavity.
